(19) United States
(12) Patent Application Publication
(10) Pub. No.: US 2008/0024890 A1
(43) Pub. Date: Jan. 31, 2008

(54) Vehicle passenger side exterior convex mirror that incorporates a calculated and calibrated actual distance visual indicator for safe adjacent lane changing

(76) Inventor: Stanley Abramson, Skokie, IL (US)

Correspondence Address: Stanley Abramson, 4215 Grove Street, Skokie, IL, 60076, US

(21) Appl. No.: 11/494,197

(22) Filed: Jul. 28, 2006

(51) Int. Cl. G02B 5/08

(52) U.S. Cl. 359/838; 359/871

(57) ABSTRACT

A standard automobile spherical convex mirror incorporating a clearly defined visual safe actual distance indicator for vehicles in adjacent lanes that determines safe adjacent lane changing, when used as a exterior side view mirror, on the passenger side of the automobile or the right exterior side of any motorized vehicle using streets, highways, toll roads contains a specifically designated safe distance interval detection area on the mirror itself that indicates that vehicles in the calculated and marked preferred rectangular interval detection area of the mirror are beyond the preferred 50 or more feet and that it is safe to signal and change to the adjacent traffic lane to the right of the vehicle containing this unique mirror. This defined specific field of view increases the chances of the driver of making a safe change of adjacent lanes. This modified mirror helps take the guess work out of determining distance of other vehicles in the field of vision of the convex mirror and if it is safe to make a lane change to the adjacent right lane. The converse is also true that any vehicle displayed beyond the borders of the marked rectangular detection area of the mirror visually indicates not safe to change to adjacent lanes. A unique margin of driving safety is now provided.

### REFERENCES

U.S. Pat. Documents

| | | |
|---|---|---|
| 3825324 | July 1974 | Brewington |
| 4727302 | February 1988 | Mizuta et al. |
| 4786156 | November 1988 | Kotani et al. |
| 4834522 | May 1989 | Janowicz |
| 4907870 | March 1990 | Brucker |
| 4971430 | November 1990 | Lynas |
| 5033835 | July 1991 | Platzer, Jr. |
| 5566028 | October 1996 | Wodeslavsky |
| 5668675 | September 1997 | Fredricks |

### BACKGROUND

There are numerous vehicle blind spot monitoring systems developed that basically are designed to electronically or manually maneuver either inside or exterior vehicle mirrors or a mirror designed with some sort of additional convexity to pick up vehicles in blind spots behind and along side of the vehicle. Also there are electronic devices that incorporate radar or laser type sensing devices to signal proximity of a vehicle usually directly behind or in front of the thus equipped vehicle. There is no device currently incorporated on OEM equipped convex and flat sphere exterior or interior vehicle mirrors that use a calculated and embedded graphical safety interval designation on these exterior or interior mirrors that provide a specific visual indication of actual distance vehicles in adjacent lanes are from these exterior mirrors. Thus, indicating to the vehicle operator that there is adequate distance between a vehicle in an adjacent lane and their vehicle to make a safe change into the adjacent lane.

### SUMMARY OF THE INVENTION

This invention incorporates a method that creates a calibrated visual zone that when embedded on or applied to an interior rear view mirror and/or exterior passenger side and/or driver side mirror provides a quick and simple visual alert of the actual distance of approaching vehicles in adjacent lanes. The actual preferred distance is calibrated and embedded on the respective mirrors to indicate a preferred minimum distance for safe adjacent lane changing. The problem of distance judgment is eliminated relative to adjacent lane changing.

### DESCRIPTION OF INVENTION

This invention embodies a method for creating a new type of exterior vehicle mirrors that enable the driver of the vehicle to safely change to adjacent lanes because the driver will now be able to have a specific visual indicator of actual distance vehicles in adjacent lanes are from the exterior vehicle mirrors. The indicator of actual distance is based on a calculated minimum distance for safe adjacent lane changing. The preferred minimum distance for safe adjacent lane changing between vehicles in the adjacent lane is based on the published vehicle safety data the indicates it takes a vehicle traveling at 40 to 60 miles per hour approximately 10 feet for every 10 miles per hour it is traveling to make an emergency stop. Therefore, a technician sitting in the driver's seat of a vehicle looking at the passenger side exterior convex mirror while another technician measures off the preferred 50 feet distance from the convex mirror to the front of a vehicle situated in the adjacent lane will be able to determine the size of the vehicle image in the adjacent lane from the preferred 45 foot minimum distance from the passenger side convex mirror. Once the image size is isolated on the preferred center surface of the convex mirror a preferred rectangular frame encompassing that vehicle image is determined and then measurements of that frame are provided to the OEM in order to embed that preferred rectangular frame on the convex mirror. The benchmark preferred convex mirror used for this method contains a convexity of 20-25 degrees which is usually the preferred standard with most vehicles. The convexity of the mirror will dictate the height of the preferred rectangular visual frame. The convex mirror with a convexity of 20-25 degrees would generate a safe distance preferred rectangular visual frame incorporating the preferred 50 feet safe adjacent lane changing minimum distance that would be 1 inch in height in the preferred center of the convex mirror and run the preferred entire horizontal width of the convex mirror. A typical flat surface mirror found on most driver's side of a vehicle using the same calculations and calibration techniques as used for the convex mirror would produce a safe distance preferred rectangular visual frame incorporating the preferred 50 feet minimum safe adjacent lane changing distance that would be 2 inches in height in the preferred center of the flat surface mirror and run the preferred entire horizontal width of the flat surface mirror. Of equal importance is the fact that a vehicle visual image in an adjacent lane falling outside of the embedded preferred rectangular visual frame would instantly visually signal the driver that a vehicle in the adjacent lane is too close for safe adjacent lane changing.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A passenger side external convex mirror that provides a standard convex mirror incorporating a calculated and graphically designated preferred rectangular safe distance interval area in the preferred horizontal center of the mirror that indicates actual preferred minimum distance for safe adjacent lane changing of vehicles from the mirror image. Eliminates the problem of distance judgment relating to vehicles in adjacent lanes.

2. The convex mirror in claim 1. if 6″ in width and 4″ in height and containing a Original Equipment convexity of 20-30 degrees would have a center point that would be 3 inches from each side and 2 inches from the top and bottom thus the determined preferred defined horizontal safe distance interval on or embedded in the convex mirror would be total 1 inch in vertical height and its boundaries would be 1½ inches from the top and bottom of the mirror and this safe lane changing interval would extend across the entire horizontal 6 inch area of the mirror. The preferred safe lane distance changing interval area on the convex mirror would be a preferred rectangular shape 1 inch in height and 6 inches wide centered horizontally in the convex mirror.

3. The preferred rectangular area designated claim 2. can be incorporated in or on the surface of the convex mirror by Original Equipment Manufacturers using selected reflective colors, electronic detection devices or other electrically generated or graphic techniques in/or on the mirror to designate and distinguish the safe lane changing distance interval that has been calculated for the given convexity of the mirror being used.

4. The convex mirror incorporating the safe lane changing distance interval indicator aftermarket by applying a reflective decal, overlay or related graphical adhesive product, incorporating and displaying the correctly calculated preferred rectangular safe lane changing interval based on the convexity of the mirror, horizontally centered and to the surface of the convex mirror.

5. Claims 1. thru claim 4. can also be calculated and applied to flat non-spherical mirrors.

6. The rectangular calculated, shaped and designated safety distance interval area on a flat surface mirror would be the calculated, centered and preferred 2 inches in height and 6 inches in width to convey vehicles viewed in the left hand exterior driver's side mirror as being the preferred 50 or more feet behind the driver's side flat surface mirror for safe adjacent lane changing.

7. The dimensions of the rectangular safety distance interval on both the convex and flat mirrors can contain multiple calculated rectangular safety distance intervals within the preferred rectangular interval to convey longer distances of vehicles from the respective mirrors due to higher rates of vehicle speeds that may have to be taken in to consideration for safe lane changing distances.

8. Vehicles images in adjacent lanes extending over and beyond the designated rectangular safety distance interval on either the convex or flat surface outside driver and passenger side mirrors would be conveying a do not change to adjacent lanes visual message due to 50 feet or less of proximity of the vehicle displayed outside of designated safe to change lane rectangular safety interval of the respective mirrors.

9. The rectangular safety distance interval on the convex or flat surface exterior mirrors can be adjusted remotely using electrical devices to enlarge or shorten the electrically generated rectangular interval image, thus the distance the vehicles appear from the mirrors on the convex and flat surface mirrors.

10. The rectangular safety distance interval on the convex and flat surface mirrors can be color coded or tinted to designate various vehicle distances from the mirrors.

11. The rectangular safety distance interval of the flat plane and convex exterior mirrors can indicate safe actual distance from approaching vehicles to initiate a turn or permit the safe opening of vehicle doors into adjacent lanes of vehicle traffic.
